(19) United States
(12) Patent Application Publication
(10) Pub. No.: US 2026/0017742 A1
(43) Pub. Date: Jan. 15, 2026

(54) APPARATUS AND METHOD FOR ANALYZING COUNTER FORCE BASED ON MULTI-AGENT REINFORCEMENT LEARNING FOR MILITARY OPERATION

(71) Applicant: AGENCY FOR DEFENSE DEVELOPMENT, Daejeon (KR)

(72) Inventors: Sangheun SHIM, Daejeon (KR); Kiwoong PARK, Daejeon (KR); Dong Kuk RYU, Daejeon (KR); Beom Ki KIM, Daejeon (KR)

(21) Appl. No.: 19/193,437

(22) Filed: Apr. 29, 2025

(30) Foreign Application Priority Data
Jul. 10, 2024 (KR) 10-2024-0091379

(51) Int. Cl. G06Q 50/26; G06Q 10/0631

(52) U.S. Cl. CPC G06Q 50/26; G09B 9/003

(57) ABSTRACT

A method for analyzing counter forces may include acquiring information on a battlefield, information on enemy threats, information on an avenue of approach, and information on enemy forces to combat with friendly forces to be allocated to the avenue of approach, and allocating, by a maneuver force agent of a multi-agent reinforcement learning model, friendly maneuver units to the avenue of approach, and generating, by an artillery force agent of the multi-agent reinforcement learning model, a list of enemy targets to fire to friendly artillery units, based on the information on the battlefield, the information on the enemy threats, the information on the avenue of approach, and the information on the enemy forces. The method may also include allocating, maneuver forces and artillery forces of friendly forces in response to the enemy threats according to a result of autonomous combat between the friendly forces and the enemy forces.

### CROSS REFERENCE TO RELATED APPLICATION

The present application claims priority to Korean Patent Application No. 10-2024-0091379, filed on Jul. 10, 2024, the entire contents of which are hereby incorporated by this reference.

### BACKGROUND

### Technical Field

The disclosure relates to an apparatus and method for analyzing counter forces based on multi-agent reinforcement learning in military operations.

### Description of Related Technology

Due to the high complexity and rapid situational changes in modern battlefields, the ability to quickly and accurately analyze and assess large-scale and heterogeneous information for operational command decision-making is required. In particular, the capability to plan and propose countermeasures against the possible actions of the adversary in warfare is essential. Especially in future battlefields, the speed and complexity of operations are likely to exceed the cognitive capacity of commanders responsible for command and control processes that are centered on manual labor. Accordingly, the importance of artificial intelligence technology that may utilize various information on a battlefield to provide commanders with analysis results on the battlefield is increasing.

### SUMMARY

In order to apply multi-agent reinforcement learning to actual military operations, an approach may be considered in which a single learning model is trained on various battlefield scenarios, and the trained multi-agent reinforcement learning model is applied to new battlefield scenarios to enhance generalization performance. That is, a learning methodology may be explored in which the trained reinforcement learning model is applied even to newly occurring and previously untrained various battlefield situations, thereby supporting commanders in making appropriate decisions.

According to an embodiment, there is provided an apparatus and method for analyzing counter forces based on multi-agent reinforcement learning for military operations, in which a multi-agent reinforcement learning model including a maneuver force agent and an artillery force agent allocates the maneuver forces and artillery forces of friendly forces in response to enemy threats, based on information on a battlefield, information on enemy threats, and information on an avenue of approach.

However, the problem to be solved by the present disclosure is not limited to that mentioned above, and other problems to be solved that are not mentioned may be clearly understood by those of ordinary skill in the art to which the present disclosure belongs from the following description.

In accordance with a first aspect of the present disclosure, there is provided a method for analyzing counter forces to be performed by a multi-agent reinforcement learning based analyzing counter forces apparatus based on multi-agent reinforcement learning for military operations, the method comprising: acquiring information on a battlefield, information on enemy threats, information on an avenue of approach, and information on enemy forces to combat with friendly forces to be allocated to the avenue of approach as a result of counter force analysis; allocating, by a maneuver force agent of a multi-agent reinforcement learning model, friendly maneuver units to the avenue of approach, and generating, by an artillery force agent of the multi-agent reinforcement learning model, a list of enemy targets to fire to friendly artillery units, based on the information on the battlefield, the information on the enemy threats, the information on the avenue of approach, and the information on the enemy forces; and allocating, by the multi-agent reinforcement learning model, maneuver forces and artillery forces of friendly forces in response to the enemy threats according to a result of autonomous combat between the friendly forces and the enemy forces determined by the multi-agent reinforcement learning model through a battlefield environment simulation corresponding to a generation of the friendly maneuver units and an allocation of the list of enemy targets, wherein, the list of enemy targets to fire to the friendly artillery units is generated, in order to allocate forces of the friendly artillery units to enemy targets within the list of enemy targets, each of the enemy targets is defined as an agent and actions are defined as amounts of the forces of the friendly artillery units is allocated to the respective enemy targets, so that each action has a real number value in a range of 0 to 1 and has a dimension fixed to one.

In accordance with a second aspect of the present disclosure, there is provided a non-transitory computer-readable storage medium storing a computer program, wherein the computer program, when executed by a processor, comprises an instruction for causing the processor to perform the method for multi-agent reinforcement learning based analyzing counter forces for military operations.

In accordance with a third aspect of the present disclosure, there is provided a non-transitory computer-readable storage medium storing a computer program, wherein the computer program, when executed by a processor, comprises an instruction for causing the processor to perform the method for multi-agent reinforcement learning based analyzing counter forces for military operations.

In accordance with a fourth aspect of the present disclosure, there is provided an apparatus, the apparatus comprising: a memory storing at least one instruction; and a processor executing the at least one instruction, wherein the at least one instruction, when executed by the processor, causes the processor to: acquire information on a battlefield, information on enemy threats, information on an avenue of approach, and information on enemy forces to combat with friendly forces to be allocated to the avenue of approach as a result of counter force analysis; allocate, by a maneuver force agent of a multi-agent reinforcement learning model, friendly maneuver units to the avenue of approach, and generating, by an artillery force agent of the multi-agent reinforcement learning model, a list of enemy targets to fire to friendly artillery units, based on the information on the battlefield, the information on the enemy threats, the information on the avenue of approach, and the information on the enemy forces; and allocate, by the multi-agent reinforcement learning model, maneuver forces and artillery forces of friendly forces in response to the enemy threats according to a result of autonomous combat between the friendly forces and the enemy forces determined by the multi-agent reinforcement learning model through a battlefield environment simulation corresponding to a generation of the friendly maneuver units and an allocation of the list of enemy targets, wherein, the list of enemy targets to fire to the friendly artillery units is generated, in order to allocate forces of the friendly artillery units to enemy targets within the list of enemy targets, each of the enemy targets is defined as an agent and actions are defined as amounts of the forces of the friendly artillery units is allocated to the respective enemy targets, so that each action has a real number value in a range of 0 to 1 and has a dimension fixed to one.

According to an embodiment, a multi-agent reinforcement learning model including a maneuver force agent and an artillery force agent allocates the maneuver forces and artillery forces of friendly forces in response to enemy threats based on information on a battlefield, information on enemy threats, and information on an avenue of approach. Accordingly, the multi-agent reinforcement learning-based application for military operation planning may be utilized to support commander decision-making. The limited cognitive capacity of military commanders is abstracted into avenues of approach through computer simulation to simulate combat scenarios, and multi-agent reinforcement learning that simultaneously considers both maneuver and artillery forces is applied. A hierarchical extensibility is achieved through a structure in which data of subordinate echelons simulated in the computer simulation is embedded into higher echelons to support decision-making by upper-echelon commanders. Further, a learning network structure that takes into account the importance of specific information in a situation where full information is shared, such as in a military operational situation, is expected to be applicable to other fields that analyze and model similar situations.

### BRIEF DESCRIPTION OF THE DRAWINGS

FIG. 1 is a block diagram illustrating a configuration of an apparatus for analyzing counter forces based on multi-agent reinforcement learning for military operations for military operations according to an embodiment of the disclosure.

FIG. 2 is a flowchart for describing a method of analyzing counter forces based on multi-agent reinforcement learning for military operations according to an embodiment of the disclosure.

FIG. 3 is a conceptual diagram illustrating a reinforcement learning process of counter force analysis in the method of analyzing counter forces based on multi-agent reinforcement learning for military operations according to an embodiment of the disclosure.

FIG. 4 is a conceptual diagram illustrating a counter force allocation process in the method of analyzing counter forces based on multi-agent reinforcement learning for military operations according to an embodiment of the disclosure.

FIG. 5 is a structural diagram illustrating company-level embedding and attention networks for counter force allocation in the method of analyzing counter forces based on multi-agent reinforcement learning for military operations according to an embodiment of the disclosure.

FIG. 6 is an exemplified diagram illustrating the combat learning environment within the battlefield environment simulation in the method of analyzing counter forces based on multi-agent reinforcement learning for military operations according to an embodiment of the disclosure.

FIG. 7 is a structural diagram illustrating a learning environment for counter force allocation in the method of analyzing counter forces based on multi-agent reinforcement learning for military operations according to an embodiment of the disclosure.

FIG. 8 is a structural diagram of the multi-agent reinforcement learning model in the method of analyzing counter forces based on multi-agent reinforcement learning for military operations according to an embodiment of the disclosure.

### DETAILED DESCRIPTION

Reinforcement learning, which is one of the learning methodologies of such artificial intelligence technology, is a method in which an agent learns to make decisions in order to maximize a given reward as well as to achieve a goal through the trial and error of the decision-making while interacting with a computer simulation or real-world environment. Through reinforcement learning, appropriate decision-making for achieving specific objectives in a given state may be supported.

Conventional decision-making support methods based on reinforcement learning have been mainly conducted based on computer strategy game simulation environments, rather than training environments that consider realistic military operations. In order for an agent in such computer games to determine a series of optimal behaviors over time, a reinforcement learning model network learns by repeatedly training on a single scenario, during which the parameters within the network are updated and trained. Particularly, multi-agent reinforcement learning is a method in which two or more agents not only interact with the environment but also with the agents to learn optimal action policies to achieve a common objective, such as combat or victory in a game. The limitation of multi-agent reinforcement learning applied to computer strategy game simulation environments is that it only optimizes the actions of multi-agents at every discrete time unit within a single scenario.

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

In describing the embodiments of the present invention, detailed descriptions of well-known functions or configurations may be omitted when it is determined that such descriptions could unnecessarily obscure the gist of the present invention. Furthermore, the terms used below are defined in consideration of the functions of the embodiments of the present invention, and may vary depending on the intentions or practices of users or operators. Therefore, the definitions should be made based on the overall content of this specification.

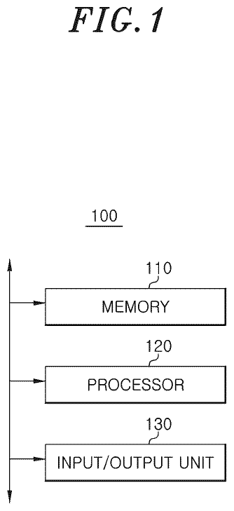

FIG. 1 is a block diagram illustrating a configuration of an apparatus for analyzing counter forces based on multi-agent reinforcement learning for military operations for military operations according to an embodiment of the disclosure.

With reference to FIG. 1, an apparatus 100 for analyzing counter forces based on multi-agent reinforcement learning according to the embodiment includes a memory 110 and a processor 120, and may further include an input/output unit 130. The apparatus 100 for analyzing counter forces based on multi-agent reinforcement learning may be implemented as a computer apparatus including the memory 110, the processor 120, and the input/output unit 130, but is not limited thereto.

A computer program including at least one instruction is stored in the memory 110 so that, when the instruction is executed by the processor 120, the processor 120 may perform a method of analyzing counter forces based on multi-agent reinforcement learning.

The processor 120 executes the instruction included in the computer program stored in the memory 110 to acquire information on a battlefield, information on enemy threats, information on an avenue of approach, and information on enemy forces to engage with friendly forces to be allocated to the avenues of approach as a result of the counter force analysis. Here, the information on the battlefield may include information on the positions and damage states of one or more forces among infantry platoons, tank platoons, and artillery units of enemy military and friendly forces. The information on the enemy threats may include one or more pieces of information among predicted acts of the enemy military, threat levels, and threat priorities. The predicted acts of the enemy military may include one or more of tactical maneuver, firepower attack, occupation, or bypass so as to include items defined in tactical doctrines. The threat level is numerical data analyzed by arithmetically considering acts of an enemy and the probability that the enemy units attack the friendly units, and the threat priority may be a value defined in a sequence according to a relative magnitude of the threat level. The information on the avenue of approach may be a path along which the maneuver forces of the enemy military and the friendly forces move for combat.

In addition, the processor 120, based on the information on the battlefield, the information on the enemy threats, the information on the avenue of approach, and the information on the enemy forces, allows the maneuver force agent of the multi-agent reinforcement learning model to allocate friendly maneuver units to the avenues of approach, and the artillery force agent of the multi-agent reinforcement learning model to allocate a list of enemy targets to fire to the friendly artillery units. Here, the information on the avenue of approach may be embedded to be applied to the combat learning environment of the battlefield environment simulation, and provided to the multi-agent reinforcement learning model

Further, according to the result of autonomous combat between friendly and enemy forces through the battlefield environment simulation corresponding to the allocation of friendly maneuver units and the allocation of enemy target lists, the processor 120 allows the multi-agent reinforcement learning model to allocate maneuver forces and artillery forces of the friendly forces in response to the enemy threats. Here, the allocation of maneuver forces and artillery forces of the friendly forces in response to enemy threats may include allocation of maneuver forces to the avenues of approach and allocation of artillery forces to enemy targets included in the enemy target list.

The input/output unit 130 may receive, as input, various types of information to enable the processor 120 to perform the method of analyzing counter forces based on multi-agent reinforcement learning, and may output various processing results performed by the processor 120.

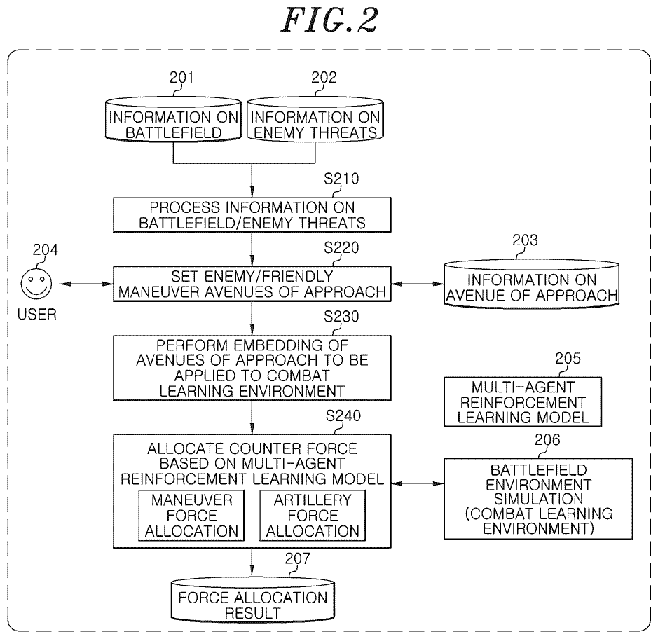

FIG. 2 is a flowchart for describing a method of analyzing counter forces based on multi-agent reinforcement learning for military operations according to an embodiment of the disclosure.

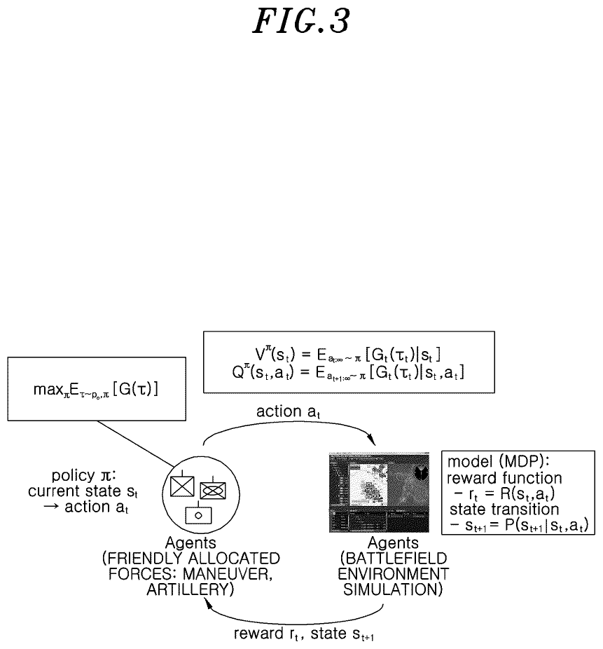

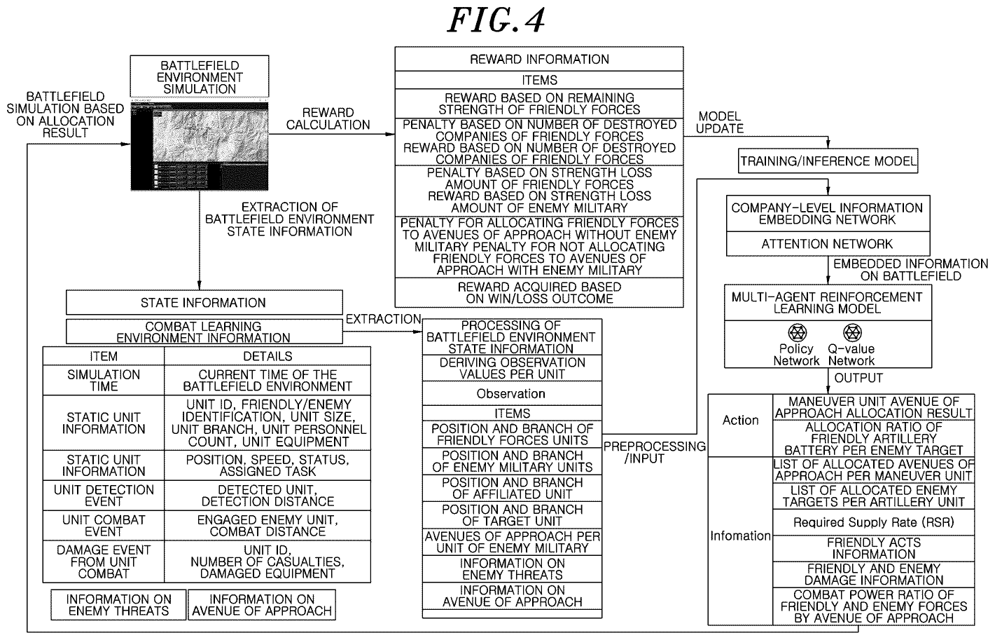

FIG. 3 is a conceptual diagram illustrating a reinforcement learning process of counter force analysis in the method of analyzing counter forces based on multi-agent reinforcement learning for military operations according to an embodiment of the disclosure, and FIG. 4 is a conceptual diagram illustrating a counter force allocation process in the method of analyzing counter forces based on multi-agent reinforcement learning for military operations according to an embodiment of the disclosure.

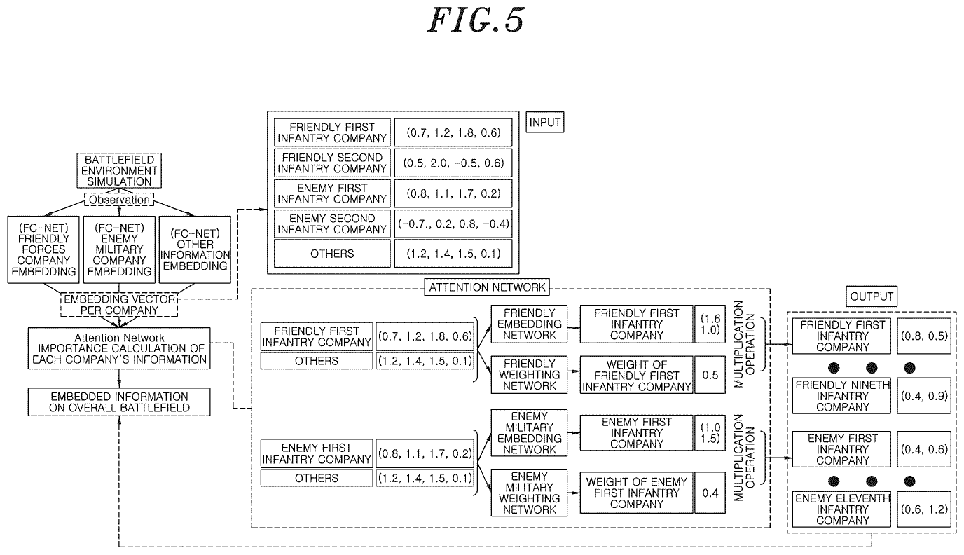

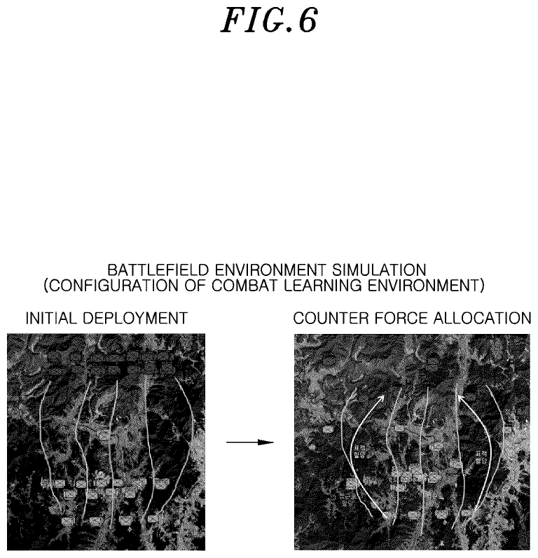

FIG. 5 is a structural diagram illustrating company-level embedding and attention networks for counter force allocation in the method of analyzing counter forces based on multi-agent reinforcement learning for military operations according to an embodiment of the disclosure, and FIG. 6 is an exemplified diagram illustrating the combat learning environment within the battlefield environment simulation in the method of analyzing counter forces based on multi-agent reinforcement learning for military operations according to an embodiment of the disclosure.

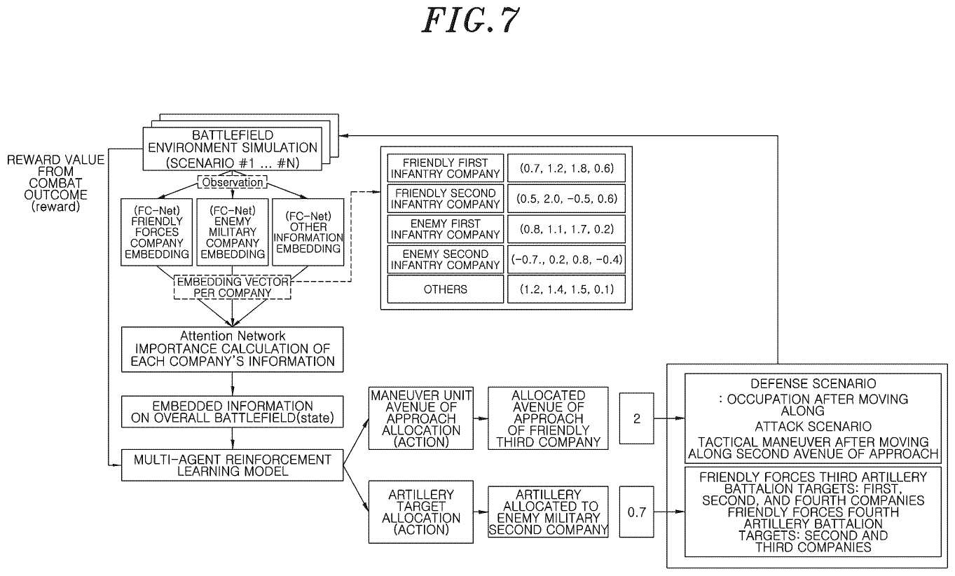

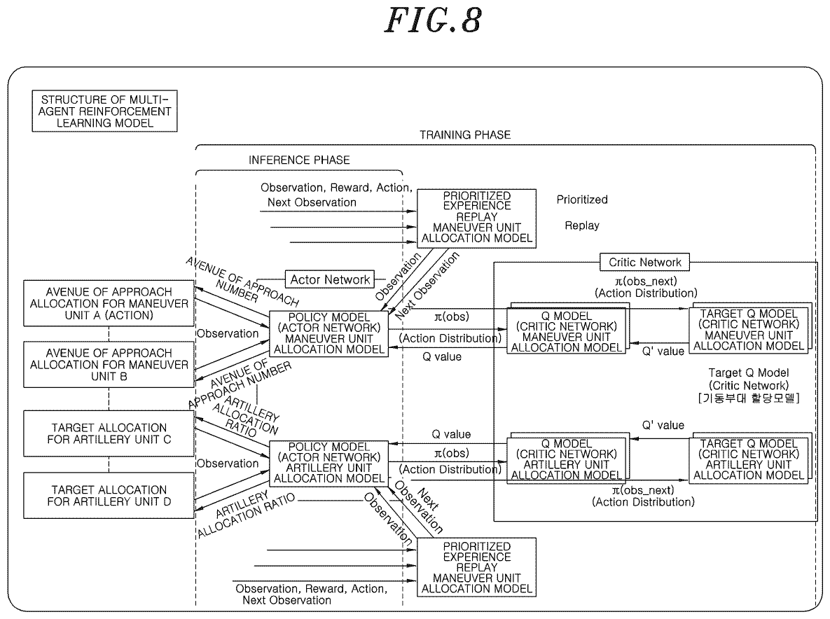

FIG. 7 is a structural diagram illustrating a learning environment for counter force allocation in the method of analyzing counter forces based on multi-agent reinforcement learning for military operations according to an embodiment of the disclosure, and FIG. 8 is a structural diagram of the multi-agent reinforcement learning model in the method of analyzing counter forces based on multi-agent reinforcement learning for military operations according to an embodiment of the disclosure.

Hereinafter, with reference to FIGS. 1 to 8, the method of analyzing counter forces based on multi-agent reinforcement learning performed by the apparatus 100 for analyzing counter forces based on multi-agent reinforcement learning for military operations according to an embodiment of the disclosure will be described in detail.

First, reinforcement learning is a method of training an agent so that an agent in a specific environment achieves a goal by making a decision called an action (a) through interaction with a given environment. The ultimate objective of reinforcement learning is to optimize a policy by which the agent explores various states (s) and determines the optimal action to receive the maximum reward in a specific situation. The policy refers to a stochastic policy, π(s|a) that probabilistically selects an action (a) to take when a certain state (s) is given. If the agent follows the policy π at time t, π(s|a) represents the probability distribution (=P[Aₜa|Sₜ=s], where A and S respectively are the total set of (finite) states and actions), over the action a to be taken in the current state (s) meaning the probability of selecting an action (a), and π may be referred to as the agent's decision-making rule at time t. Counter force analysis refers to deriving the outcome of optimal allocation (=action, a) of maneuver/artillery forces of the friendly forces to maximize the expected value

$$( {max}_{τ} {E}_{τ} - \text{?} τ [ G ( τ ) ] )$$

$$\text{?} \text{indicates text missing or illegible when filed}$$

of a reward (t) according to objectives of the battlefield such as effective responses of friendly forces to enemy threats, when state information (s) is given via a battlefield environment simulation that includes friendly/enemy forces and information on the battlefield, as illustrated in FIG. 3. That is, with the optimal policy (π) for decision-making, the agent, which represents friendly forces, derives which enemy forces should be allocated as targets and engaged in a particular state of the battlefield environment.

In this case, t refers to a time at a specific time step, and r refers to trajectory data (=(s₀,a₀,r₀,s₁,a₁,r₁, . . . )) over time, which the sequence data of a series of states, agent action, and resultant reward information over time. V^{π}(sₜ) denotes the state-value function of the policy (π), representing the depreciated total sum of future values to be obtained when following the policy (π) from the current (t) state (sₜ). Gₜ refers to the return, which is defined as the depreciated total sum of rewards expected after time t, as shown in the following equation.

$${G}_{t} = {r}_{i + 1} + γ {r}_{t + 2} + {γ}^{2} {r}_{t + 3} + {γ}^{3} {r}_{t + 4} + \text{?} = {\sum }_{k = 0}^{∞} {γ}^{k} {r}_{t + k + 1} ,$$

$$\text{?} \text{indicates text missing or illegible when filed}$$

in this case, [symbol] refers to the discount rate (0≤ [symbol] ≤1), which represents the rate at which value decreases over time. B_{z}[⋅] denotes the expected value of a random variable at time t for an agent following policy π. Accordingly, E [symbol] [Gₜ(τₜ)|sₜ] may be defined as the expected value of the reward function, which is expected after the current (t) state (sₜ), when a random variable representing the agent's action aₜ follows the policy π(s|a), which is a probability distribution, and traverses the trajectory (τₜ).

W^{τ}(sₜ·aₜ) refers to the action-value function, which is the expected value of the return (Gₜ), which may be obtained when taking a specific action (aₜ) in a state (sₜ) and then following the policy (π). E [symbol] [G(τ)] denotes the expected value of the return (G(τ)), when a trajectory (τ) is sampled based on a combination of the probability distribution in an initial state (=P₀, the probability distribution over the states from which the agent's trajectory starts) and a policy (π). Reinforcement learning is to find a policy

$$( {max}_{τ} {E}_{τ} - \text{?} τ [ G ( τ ) ] )$$

$$\text{?} \text{indicates text missing or illegible when filed}$$

that maximizes the expected value of the total reward over the agent's trajectory (t).

The processor 120 of the apparatus 100 for analyzing counter forces based on multi-agent reinforcement learning performs the method of analyzing counter forces based on multi-agent reinforcement learning according to an embodiment by executing the instructions of a computer program stored in the memory 110.

According to the method of analyzing counter forces based on multi-agent reinforcement learning, first, the apparatus 100 for analyzing counter forces based on multi-agent reinforcement learning acquires information on a battlefield 201, information on enemy threats 202, information on an avenue of approach 203, and information on enemy forces to engage with friendly forces to be allocated to the avenues of approach as a result of the counter force analysis. Then, to perform reinforcement learning through interaction with a battlefield environment simulation 206, key information is extracted from the battlefield environment information and the information on the enemy threats and delivered as input to the learning model. In this case, the key information corresponds to the position of each unit, service types, avenues of approach for each unit of the enemy military, and information on the avenue of approach, etc. For efficient learning, each piece of information delivered as input to the learning model is processed to be normalized to a range of −1 to 1 or 0 to 1 for numerical data, and one-hot encoded for categorical data (e.g., apple, pear, tangerine→[0 0 1], [0 1 0], [1 0 0]). The information delivered from the battlefield environment simulation 206 is grouped into company-level agent information and input to an artificial neural network, such that each company-level information is embedded in vector form (S210).

Here, the information on the avenue of approach 203 may allow a user 204 to retrieve the pre-stored information on the avenue of approach and to set the attribute values of the avenue of approach. A maneuver avenue of approach refers to a land route in the battlefield environment simulation over which maneuver forces such as infantry or tanks move and engage with enemy forces or friendly forces, and refers to data that includes a list of attributes and corresponding attribute values such as latitude/longitude, barbed wire, minefield, terrain, and vehicle mobility. When defining an avenue of approach, rather than utilizing actual terrain information data, the quantified attribute values of the avenue of approach may be defined based on qualitative factors considered by the commander during the operation planning process, such as maneuvering distance and space, terrain shape, presence or number of obstacles, and accessibility (S220).

Table 1 illustrates an example configuration of avenue of approach attributes.

TABLE 1

| Avenue of | Avenue of | Barbed | Minefield | | |
|---|---|---|---|---|---|
| approach | approach | Wire Path | Range | | Vehicle |
| Name | Path (Lat/Lng) | (Lat/Lng) | (Lat/Lng) | Terrain | Mobility |
| Avenue of | [[37.8, 127.0], | [[38.0, 127.0], | [[38.0, 127.0], | Field 20%, | Not |
| approach 1 | [38.0, 127.2], | [38.1, 126.9]] | [38.1, 127.1], | Mountain 30%, | Allowed |
| | [38.1, 126.9], | | [37.9, 126.9]] | Road 50% | |
| | [38.3, 127.1]] | | | | |

In the training phase, the information on the avenue of approach is automatically generated to have various avenue of approach attributes so that training is performed, and in the inference phase, the user may retrieve and modify a desired avenue of approach as an analysis target among a plurality of given avenues of approach, select the analysis target avenue of approach, and perform inference based on the corresponding avenue of approach.

The information on the avenue of approach may be embedded to be applied to the combat learning environment of the battlefield environment simulation, and provided to the multi-agent reinforcement learning model.

The avenue of approach is reflected as environmental information in the battlefield environment simulation 206, where the units of enemy military and friendly forces move and engage, and at the same time, the information on the avenue of approach needs to be embedded so that the artificial intelligence learning model may learn the features of the avenue of approach. Since the avenue of approach may have variable information dimensions for storage depending on the complexity of the path and terrain, etc., it is necessary to convert such variable-sized information into fixed-sized information for the application of input data to an artificial neural network, which is a mathematical model. Therefore, to convert variable-sized information into fixed-sized information, the start and end points of the avenue of approach may be set, and the path therebetween may be then divided into N equal segments to reconstruct the information. The number of segments for dividing the avenue of approach may be adjusted depending on the scale of the battlefield environment. For example, the avenue of approach may be divided into two equal segments based on latitude and longitude.

TABLE 2

| Avenue of | Avenue of | | | | |
|---|---|---|---|---|---|
| approach | approach | Barbed Wire | Minefield | Representative | Vehicle |
| Name | Path (Lat/Lng) | Presence | Presence | Terrain | Mobility |
| Avenue of | [[37.8, 127.0], | None | Present | Field | Not |
| approach 1 | [38.0, 127.2]] | | | | Allowed |
| | [[38.0, 127.2], | Present | None | Road | |
| | [38.2, 127.1]] | | | | |

According to the attribute values of avenues of approach divided into N segments, numerical data such as latitude and longitude is normalized to a range of 0 to 1 or −1 to 1, and categorical data such as the presence of barbed wire or representative terrain is preprocessed using one-hot encoding and then input as training data.

Based on the information on the battlefield, the information on the enemy threats, the information on the avenue of approach, and the information on the enemy forces, the processor 120 allows the maneuver force agent of the multi-agent reinforcement learning model 205 to allocate friendly maneuver units to avenues of approach, and the artillery force agent of the multi-agent reinforcement learning model to allocate a list of enemy targets to fire to the friendly artillery units.

Further, according to the result of autonomous combat between friendly forces and enemy forces through the battlefield environment simulation corresponding to the allocation of friendly maneuver units and the allocation of enemy target lists, the processor 120 allows the multi-agent reinforcement learning model to allocate maneuver forces and artillery forces of the friendly forces in response to the enemy threats. Here, when the maneuver forces and artillery forces of the friendly forces are allocated in response to the enemy threat, a force allocation result 207 may be generated, including allocation of the maneuver force to the avenue of approach and allocation of the artillery force to enemy targets included in the list of enemy targets (S240).

For multi-agent reinforcement learning model-based counter force allocation, as illustrated in FIG. 4, a state refers to the state information, information on the enemy threats, and information on the avenue of approach extracted through the battlefield environment simulation, and an observation refers to a value obtained by excluding information such as unit names that are insignificant or difficult for the friendly forces side to know (e.g., affiliation information on enemy units) from the state information. When the observation is input into the multi-agent reinforcement learning model, the maneuver force agent allocates a friendly maneuver unit to one of the avenues of approach, and the artillery force agent allocates a list of enemy targets to fire to the friendly artillery units. Autonomous combat between the enemy and friendly forces is performed through the battlefield environment simulation configured after the allocation is achieved, and based on the result thereof, a reward is acquired and the multi-agent reinforcement learning network is updated.

In military operations, since a plurality of units are involved and interaction between respective units is essential, a multi-agent reinforcement learning environment is applied to use multiple agents, in which each agent corresponds to one maneuver company or one artillery company. The company embedding structure represented in the structural diagram of FIG. 5 may use a network that embeds data into a company level through a fully-connected neural network when data is derived at a platoon level under the company in the battlefield environment simulation.

In a general multi-agent environment, it is assumed that each agent may perceive only the information around the agent. In addition, although there are cases where additional information is obtained by performing communication or the like with neighboring agents, it is not significantly different in that information is basically acquired centering on the agent. However, in case of military operations, since a commander establishes a plan with awareness of the entire battlefield, it is appropriate that, in a reinforcement learning environment for establishing military operations, the agent is considered to have information regarding the entire battlefield.

However, in this case, since the observation of the agent becomes the entire information on the battlefield, the number of input dimensions may become excessively large, and therefore, it is necessary to extract only the information that is essential to the agent from among the input values. Accordingly, an attention network presented in FIG. 5 may be applied to use a learning model structure in which the agent calculates the importance of information on other units and uses only the amount of information corresponding to the importance. In this case, the embedding network or the weight network described in FIG. 5 may be configured as a fully-connected neural network composed of one to two layers.

The battlefield environment simulation constitutes the combat learning environment for counter force analysis as illustrated in FIG. 6. In a situation where the forces of enemy military and friendly forces are initially deployed, avenue of approach allocation and target allocation are performed according to counter force allocation (action), which is an output value of the multi-agent reinforcement learning, and then mutual autonomous combat is performed.

As illustrated in FIG. 7, a reward is received according to the combat result through the battlefield environment simulation, and learning for one scenario is performed by updating the learning network of the reinforcement learning model based on the corresponding reward. In order to apply a multi-agent reinforcement learning model that is applicable even to various scenarios, a training environment structure may be used in which scenarios are generated by varying the battlefield environment information, information on the enemy threats, and information on the avenue of approach that are used as input data for the multi-agent reinforcement learning, thereby improving the generalization performance of the reinforcement learning model.

FIG. 8 illustrates the structure of the multi-agent reinforcement learning model for counter force allocation. The maneuver force agent and the artillery force agent each have an Actor Network

$$( θ ← {θ}_{o} + α \frac{∇ π ( a \vert s , θ )}{π ( a \vert s , θ )} ,$$

where a is the learning rate as a hyperparameter) that updates the Policy Model (π=s|a·θ), where θ represents the parameters of the network constituting the Policy Model), and accordingly, the Actor Network parameter (=θ) are updated based on the error values within prioritized experience replay (PER), so that respective maneuver and artillery units may select an optimal avenue of approach or artillery allocation ratio under a given situation of combat environment, thereby achieving the training. To train for diverse combat scenarios, the PER stores the data of observation, reward, action, and next observation derived through various combat learning processes, as illustrated in FIG. 8.

When extracting data samples of observation, reward, action, and next observation stored according to various combat learning scenarios, proportional prioritization

$$( P ( i ) = \frac{{p}_{i}^{a}}{{\sum }_{k} {p}_{k}^{a}} , {p}_{i} = \vert {δ}_{i} \vert + ϵ or {p}_{i} = \frac{1}{rank ( i )} ,$$

where a denotes the sensitivity of prioritization, larger values of a indicate higher emphasis on prioritization, and when a value is zero, data are extracted randomly) is applied. Instead of randomly extracting multiple data for each combat scenario situation, training is performed in a way that prioritization is applied to increase data efficiency by assigning higher priority (=rank(i)) to data with a larger error (=δₜ) from the targeted reward values or to more recently collected data according to the training.

Further, in order to evaluate the action taken by each maneuver and artillery unit according to the Actor Network, training is performed to approximate the optimal state-value function through the Critic Network (w←w₀−βΕQ_{q}(s,a), where β is the learning rate as a hyperparameter) of the Q Model (Q_{w}(s,a), where w denotes the parameters of the network constituting the Q Model). In this case, since the optimal state-value function may not be obtained directly, Temporal Difference is used, and the error, δ(=TD error)=(rₜ+γQ(aₜ₊₁,aₜ₊₁)−Q(sₜ,aₜ))^{t} is calculated based on the following equation.

Since the Q value is included in the error calculation formula, the target point continuously changes as training progresses, which may destabilize the learning process. Therefore, as shown in the structural diagram of the multi-agent reinforcement learning model below, a separate Target Q Model is defined. The Target Q Model is synchronized with the trained Q Model as fixed N training processes are performed, thereby updating the Target Q Model and adopting a structure that enhances the stability of learning.

The range of the action value for the maneuver force agent corresponds to the number of avenues of approach. For example, when there are five avenues of approach, the action value is one of 1, 2, 3, 4, or 5. When the action taken by the B-1 battalion, first infantry company agent, which represents a friendly force, is inferred as 3, it means that the corresponding friendly force is allocated to the third avenue of approach.

TABLE 3

| Avenue of | | |
|---|---|---|
| approach Name | Enemy Forces | Friendly Forces |
| Avenue of | R-1 Regiment - first Battalion - | B-1 Battalion - first |
| approach 1 | first Infantry Company, | Infantry Company, |
| | R-1 Regiment - first Battalion - | B-1 Battalion - |
| | second Infantry Company, | second |
| | R-1 Regiment - first Battalion - | Infantry Company |
| | third Infantry Company | |
| Avenue of | R-1 Regiment - second Battalion - | B-2 Battalion - first |
| approach 2 | fourth Infantry Company, | Tank Platoon |
| | R-1 Regiment - second Battalion - | |
| | second Tank Platoon | |
| Avenue of | R-2 Regiment - first Battalion - | B-2 Battalion - third |
| approach 3 | second Infantry Company, | Infantry Company, |
| | R-5 Regiment - second Battalion - | |
| | third Infantry Company, | B-3 Battalion - |
| | R-5 Regiment - second Battalion - | second |
| | 5th Infantry Company | Tank Platoon |

In case of a friendly artillery force agent, enemy targets to be allocated to the friendly artillery unit need to be inferred, and the number of targets varies depending on the number of enemy forces that are to become targets. Therefore, when enemy targets to be allocated to the artillery force agent of the friendly forces are directly inferred, the action of the artillery force agent of the friendly forces needs to determine whether or not to allocate respective enemy forces to the friendly artillery force as a target, and accordingly, the number of enemy targets becomes the dimension of the action. For example, when there are three candidate targets and an action value of (1, 0, 0) is inferred, it means that only the first enemy force is selected as a target. In this case, the action dimension is three-dimensional. When there are five candidate targets and an action value of (0, 1, 1, 0, 0) is inferred, it means that the second and third enemy forces are selected as targets, and in this case, the action dimension is five-dimensional. That is, the action dimension varies depending on the number of targets. Since an artificial neural network, which is a mathematical model, is generally capable of accurately inferring only fixed action dimensions, separate processing is required for this.

Accordingly, in case of the artillery force agent, rather than allocating enemy targets to the friendly artillery force, a method of allocating the friendly artillery force to enemy targets is employed. In this case, an agent becomes each enemy target force, and the action may be defined as amounts of the friendly artillery forces to be allocated to the corresponding enemy force. For example, when the action value of the agent corresponding to the third company of the enemy military is 0.3, it means that 30% of the friendly artillery force targets the third company of the enemy military. When defined in this manner, the action takes a real number value in the range of 0 to 1 and has a fixed dimension of one, making it possible to perform accurate inference using an artificial neural network.

TABLE 4

| | Allocation Ratio |
|---|---|
| | of Friendly |
| | Artillery |
| Agent(Enemy) | Force (0-1) |
| R-1 Regiment - first Battalion - first | 0.6 |
| Infantry Company | |
| R-1 Regiment - second Battalion - third | 0.3 |
| Infantry Company | |
| R-2 Regiment - first Battalion - first | 0.15 |
| Tank Platoon | |

In this case, for example, it is necessary to additionally determine which friendly artillery force among the friendly artillery forces will perform the firing when 30% of the friendly artillery force is allocated to target the third infantry company of the enemy military. With reference to the current artillery force operation method, the target allocation is performed starting from the friendly artillery force that has the smallest number of allocated targets, so that all artillery forces of the friendly forces have as equal a number of targets as possible. The firing logic is as follows. For each friendly artillery force, among the allocated targets, firing is performed starting from the enemy with the highest priority within the firing range. The priority is in the order of armored→artillery→anti-tank→infantry. The type of artillery shell is used according to the effect of the shell as Armored: DPICM Artillery and anti-tank: HE+ICM, Infantry: HE. However, this may be changed according to the user's intention.

TABLE 5

| Artillery | |
|---|---|
| Force | Enemy Target Forces |
| B-150M | R-1 Regiment - first Battalion - first Infantry Company, |
| Artillery | R-1 Regiment - first Battalion - second Infantry Company, |
| Battalion - | R-1 Regiment - first Battalion - third Infantry Company, |
| A Battery | R-1 Regiment - first Battalion - fourth Infantry Company, |
| | R-1 Regiment - second Battalion - first Tank Platoon |
| B-150M | R-1 Regiment - second Battalion - first Infantry Company, |
| Artillery | R-1 Regiment - second Battalion - second Infantry Company, |
| Battalion - | R-1 Regiment - third Battalion - third Infantry Company, |
| B Battery | R-1 Regiment - third Battalion - second Tank Platoon, |
| | R-1 Regiment - first Battalion - first Tank Platoon |

As described above, according to an embodiment, a multi-agent reinforcement learning model including a maneuver force agent and an artillery force agent allocates the maneuver forces and artillery forces of friendly forces in response to enemy threats based on information on a battlefield, information on enemy threats, and information on an avenue of approach. Accordingly, the multi-agent reinforcement learning-based application for military operation planning may be utilized to support commander decision-making. The limited cognitive capacity of military commanders is abstracted into avenues of approach through computer simulation to simulate combat scenarios, and multi-agent reinforcement learning that simultaneously considers both maneuver and artillery forces is applied. A hierarchical extensibility is achieved through a structure in which data of subordinate echelons simulated in the computer simulation is embedded into higher echelons to support decision-making by upper-echelon commanders. Further, a learning network structure that takes into account the importance of specific information in a situation where full information is shared, such as in a military operational situation, is expected to be applicable to other fields that analyze and model similar situations.

A computer program may be implemented to include instructions for causing a processor to perform each step included in the method for analyzing counter forces performed by an apparatus for analyzing counter forces based on multi-agent reinforcement learning for military operations according to the above-described embodiment.

In addition, the computer program including instructions for causing a processor to perform each step included in the method for analyzing counter forces performed by an apparatus for analyzing counter forces based on multi-agent reinforcement learning for military operations to the above-described embodiment may be recorded on a non-transitory computer-readable storage medium.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

1. A method for analyzing counter forces to be performed by a multi-agent reinforcement learning based analyzing counter forces apparatus based on multi-agent reinforcement learning for military operations, the method comprising:
acquiring information on a battlefield, information on enemy threats, information on an avenue of approach, and information on enemy forces to combat with friendly forces to be allocated to the avenue of approach as a result of counter force analysis;
allocating, by a maneuver force agent of a multi-agent reinforcement learning model, friendly maneuver units to the avenue of approach, and generating, by an artillery force agent of the multi-agent reinforcement learning model, a list of enemy targets to fire to friendly artillery units, based on the information on the battlefield, the information on the enemy threats, the information on the avenue of approach, and the information on the enemy forces; and
allocating, by the multi-agent reinforcement learning model, maneuver forces and artillery forces of friendly forces in response to the enemy threats according to a result of autonomous combat between the friendly forces and the enemy forces determined by the multi-agent reinforcement learning model through a battlefield environment simulation corresponding to a generation of the friendly maneuver units and an allocation of the list of enemy targets,
wherein, the list of enemy targets to fire to the friendly artillery units is generated, in order to allocate forces of the friendly artillery units to enemy targets within the list of enemy targets, each of the enemy targets is defined as an agent and actions are defined as amounts of the forces of the friendly artillery units is allocated to the respective enemy targets, so that each action has a real number value in a range of 0 to 1 and has a dimension fixed to one.

2. The method of claim 1, wherein the information on the battlefield includes information on positions and damage states of one or more forces among infantry platoons, tank platoons, and artillery units of enemy military and friendly forces, and
wherein the information on the enemy threats includes one or more pieces of information among predicted acts of the enemy military, threat levels, and threat priorities.

3. The method of claim 2, wherein the predicted acts of the enemy military contain one or more of tactical maneuver, firepower attack, occupation, or bypass so as to have items defined in tactical doctrine.

4. The method of claim 2, wherein the threat level is numerical data analyzed by arithmetically considering acts of an enemy and a probability that enemy units attack friendly units, and
wherein the threat priority is a value defined in a sequence according to a relative magnitude of the threat level.

5. The method of claim 1, wherein the information on the avenue of approach is a path along which maneuver forces of enemy military and the friendly forces move for combat.

6. The method of claim 1, wherein the information on the avenue of approach is embedded to be applied to a combat learning environment of the battlefield environment simulation, and provided to the multi-agent reinforcement learning model.

7. The method of claim 1, wherein the allocating of the maneuver forces and the artillery forces of the friendly forces in response to the enemy threats includes:
allocating the maneuver forces of the friendly forces to the avenue of approach; and
allocating the artillery forces of the friendly forces to the enemy targets within the list of enemy targets.

8. A non-transitory computer-readable storage medium storing a computer program, wherein the computer program, when executed by a processor, includes instructions for causing the processor to perform a method, the method comprising:
acquiring information on a battlefield, information on enemy threats, information on an avenue of approach, and information on enemy forces to combat with friendly forces to be allocated to the avenue of approach as a result of counter force analysis;
allocating, by a maneuver force agent of a multi-agent reinforcement learning model, friendly maneuver units to the avenue of approach, and generating, by an artillery force agent of the multi-agent reinforcement learning model, a list of enemy targets to fire to friendly artillery units, based on the information on the battlefield, the information on the enemy threats, the information on the avenue of approach, and the information on the enemy forces; and
allocating, by the multi-agent reinforcement learning model, maneuver forces and artillery forces of friendly forces in response to the enemy threats according to a result of autonomous combat between the friendly forces and the enemy forces determined by the multi-agent reinforcement learning model through a battlefield environment simulation corresponding to a generation of the friendly maneuver units and an allocation of the list of enemy targets,
wherein, the list of enemy targets to fire to the friendly artillery units is generated, in order to allocate forces of the friendly artillery units to enemy targets within the list of enemy targets, each of the enemy targets is defined as an agent and actions are defined as amounts of the forces of the friendly artillery units is allocated to the respective enemy targets, so that each action has a real number value in a range of 0 to 1 and has a dimension fixed to one.

9. An apparatus for multi-agent reinforcement learning based analyzing counter forces for military operations, the apparatus comprising:
a memory storing at least one instruction; and
a processor executing the at least one instruction,
wherein the at least one instruction, when executed by the processor, causes the processor to:
acquire information on a battlefield, information on enemy threats, information on an avenue of approach, and information on enemy forces to combat with friendly forces to be allocated to the avenue of approach as a result of counter force analysis;
allocate, by a maneuver force agent of a multi-agent reinforcement learning model, friendly maneuver units to the avenue of approach, and generating, by an artillery force agent of the multi-agent reinforcement learning model, a list of enemy targets to fire to friendly artillery units, based on the information on the battlefield, the information on the enemy threats, the information on the avenue of approach, and the information on the enemy forces; and
allocate, by the multi-agent reinforcement learning model, maneuver forces and artillery forces of friendly forces in response to the enemy threats according to a result of autonomous combat between the friendly forces and the enemy forces determined by the multi-agent reinforcement learning model through a battlefield environment simulation corresponding to a generation of the friendly maneuver units and an allocation of the list of enemy targets,
wherein, the list of enemy targets to fire to the friendly artillery units is generated, in order to allocate forces of the friendly artillery units to enemy targets within the list of enemy targets, each of the enemy targets is defined as an agent and actions are defined as amounts of the forces of the friendly artillery units is allocated to the respective enemy targets, so that each action has a real number value in a range of 0 to 1 and has a dimension fixed to one.

10. The apparatus of claim 9, wherein the information on the battlefield includes information on positions and damage states of one or more forces among infantry platoons, tank platoons, and artillery units of enemy military and friendly forces, and
wherein the information on the enemy threats includes one or more pieces of information among predicted acts of the enemy military, threat levels, and threat priorities.

11. The apparatus of claim 10, wherein the predicted acts of the enemy military contain one or more of tactical maneuver, firepower attack, occupation, or bypass so as to have items defined in tactical doctrine.

12. The apparatus of claim 10, wherein the threat level is numerical data analyzed by arithmetically considering acts of an enemy and a probability that enemy units attack friendly units, and
wherein the threat priority is a value defined in a sequence according to a relative magnitude of the threat level.

13. The apparatus of claim 10, wherein the information on the avenue of approach is a path along which maneuver forces of enemy military and the friendly forces move for combat.

14. The apparatus of claim 9, wherein the information on the avenue of approach is embedded to be applied to a combat learning environment of the battlefield environment simulation, and provided to the multi-agent reinforcement learning model.

15. The apparatus of claim 9, wherein the at least one instruction, when executed by the processor, causes the processor further to:
allocate the maneuver forces of the friendly forces to the avenue of approach; and
allocate the artillery forces of the friendly forces to the enemy targets within the list of enemy targets.
